(19) United States
(12) Patent Application Publication
(10) Pub. No.: US 2017/0365078 A1
(43) Pub. Date: Dec. 21, 2017

(54) FRAMEWORK FOR CUSTOMIZED VISUALIZATIONS

(71) Applicant: SAP SE, Walldorf (DE)

(72) Inventors: Jerome Cailly, Bessancourt (FR); Yannick Besnehard, Paris (FR); Thai Huy Le Tat, L'Hay Les Roses (FR)

(21) Appl. No.: 15/185,093

(22) Filed: Jun. 17, 2016

(51) Int. Cl. G06T 11/20; G06F 17/30; G06F 17/24

(52) U.S. Cl. CPC G06T 11/206; G06F 17/246; G06F 17/30554

(57) ABSTRACT

Provided is a visualization framework including a visualization library and a data query language. Devices and methods are also provided for generating visualizations based on the visualization framework. As an example, a method may include selecting a layout for the visualization from among a plurality of layouts included in the visualization library, the layout defining a format for how content is spatially organized within the respective layout, binding the layout to a dataset using one or more functions from the data query language, the one or more functions comprising a repeater function defining a number of times a display of the layout is to be repeated, and displaying the visualization including the layout displayed a number of times as defined by the repeater function.

### BACKGROUND

Data visualization is used to help people understand the significance of data by placing it in a visual context. Patterns, trends and correlations that might go undetected in text-based data can be exposed and recognized more easily with data visualization. Data visualization enables analyzers to see analytics more easily allowing them to grasp difficult concepts or identify new patterns quickly and without laborious computation. With interactive visualization, a user may “drill down” into charts and graphs to view additional detail, thereby interactively changing the displayed data and the processing thereof.

Data visualization tools go well beyond the standard charts and graphs used in spreadsheets, displaying data in more sophisticated ways such as infographics, dials and gauges, geographic maps, heat maps, and detailed bar, pie and fever charts. The images may include interactive capabilities, enabling users to manipulate them or drill into the data for querying and analysis. Indicators designed to alert users when data has been updated or predefined conditions occur can also be included. As will be appreciated, visualizations of data can take many forms across many areas, and may be more useful in different forms to different organizations. However, the only tools that allow for the creation of customized visualizations require significant amounts of programming.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings, in which:

FIGS. 1A-1C are diagrams illustrating examples of positioning a shape within a visualization in accordance with example embodiments.

FIG. 2 is a diagram illustrating a visualization of two shapes placed relative to the other in accordance with an example embodiment.

FIGS. 3A-3D are diagrams illustrating layouts generated using patterns of shapes and a repeater in accordance with example embodiments.

FIGS. 4A-4F are diagrams illustrating examples of generating a column-based layout according to example embodiments.

FIGS. 5A-5C are diagrams illustrating examples of generating a bar graph based layout according to example embodiments.

FIG. 6 is a diagram illustrating a computing device for generating a visualization in accordance with an example embodiment.

FIG. 7 is a diagram illustrating a method for generating a visualization in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

One of the primary drawbacks for creating data driven customized visualizations is the lack of tools to create such custom visualizations. The examples described herein relate to a visualization framework for generating customized visualizations based on data. The framework may include or may be used with a new software library (referred to herein as a ‘visualization library’ or ‘visualization factory’) and a data query language oriented for graphical visualization and layout. The framework allows a user to create new and customized visualizations for data from a foundation of basic shapes and layouts. The framework makes use of construction by composition and allows for reuse of existing visualizations to fit different and specific needs. A representation (e.g., shapes and layouts) created using the visualization library can be reused in another representation based on the same data or based on different data using a parameterization and bidding mechanism provided by the visualization library. As an example, the visualization library may be a JavaScript graphing and charting based library that is based on a descriptive layouting language combined with the data query language. Data for the representation may be extracted or otherwise captured from data sets using one or more functions from the data query language.

According to various examples, a visualization may include one or more shapes, one or more layouts organizing shapes, and content. The layouts may be bound to data from a data file through repeaters which may be used to specify how many times a layout is repeated within a single visualization. Creating a new visualization with the visualization library includes describing the content of the visualization. To do so, a designer (e.g., programmer, analyst, engineer, user, etc.) may use a set of shapes and/or layouts which may contain contents. In these examples, shapes may contain multiple shapes and layouts may contain one or more shapes, one or more layouts, or a combination thereof. Shapes are very similar to what may be found in computer assisted drawing/diagramming tools and may include, for example, a rectangle, an ellipse, a circle, a line, a sector, a label, a polygon, and many others. Additional examples of shapes are described in Appendix A. Layouts are used to organize the visualization (or representation) into patterns. For example, layouts may expose and allow users to manipulate the spatial organization of the representation. Examples of types of layouts include bar, circular, column, flow, grid, hierarchies, a squarified map, and many others.

As described in various examples, shapes and layouts may be combined to form more sophisticated visualization content. In addition, users may build data driven visualizations by combining the layouts with various data from a data file such as a spreadsheet, .csv file, document, notepad file, and the like. The data may be extracted, collected, gathered, and the like, from the data based on functions included in the data query language. Functions of the data query language may start with keyword data to signify that current data context is to be worked on. Examples of functions included in the data query language are shown in Appendix B. Furthermore, data may be bound to the representation at the layout level using a repeater, examples of which are further described herein. Using a repeater, a designer may define the number of times that a layout is repeated in a drawing space and the number of repetition may be driven by or determined by data from a data file. For example, each repetition of a layout may define a data context and content added in each layout space in the representation may be driven by this data context. The shapes, layouts, and/or repeaters may expose properties that determine their positioning and behavior. Also, data may be exposed through data contexts and a set of tools may be provided that allow the user to navigate the dataset and define selections and/or calculations.

The shapes, layouts, and/or repeaters may be combined together and referred to as a visualization definition. Before being rendered, a visualization definition may be evaluated (all properties are resolved) in what is referred to as a visualization output that is then pushed into the rendering engine that may draw the result on a graphic display using the visualization library, and the like. According to various aspects, the dynamics of the visualization such as interactions and animations may at least be partly handled the same way and surfaced in the grammar again allowing for definition of tailored behavior. The navigation of the content and the selection and highlighting may be distinguished from one another. For example, the navigation (e.g., zoom, pan, rotate, and the like) may be handled in a viewer, and may not be exposed in the grammar. Meanwhile, selection may be exposed in the grammar allowing for full fledge customization the same way that static aspects may be exposed.

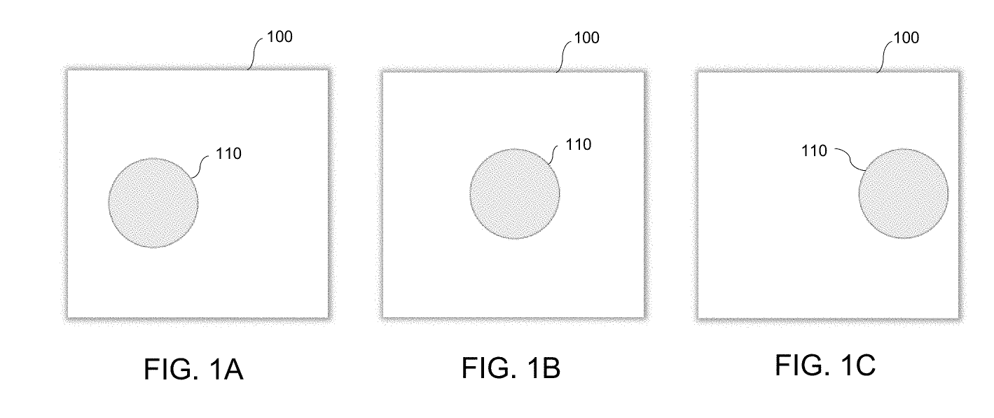

FIGS. 1A-1C illustrate examples of positioning a shape within a visualization in accordance with example embodiments. Referring to FIGS. 1A-1C, a shape of an ellipse 110 is positioned within a visualization 100 using code from the visualization library. Here, the visualization 100 has a two-dimensional shape and may include a square, or other type shape. In some examples, the visualization 100 may also be referred to as a container. The ellipse 110 is positioned at various locations within a boundary or border of the visualization 100. In FIG. 1A, the ellipse 110 is positioned at a fixed position that is set based on pixel values and which is closer to a left side of the visualization 100 than a right side of the visualization 100. A non-limiting example of code executed to generate the display of FIG. 1A is shown below.

```
viz = { // The structure of a visualization description
  version : “0.2”,
  content: [ // We define a content for the visualization which is an array of shapes or
layouts
    {
      type : ‘ellipse’, // The content of the visualization is one shape which is an ellipse
      value: {
        centerX : 100, // The absisse position of the center will be at 100px of the left
        centerY : 150, // The ordinate position of the center will be at 150px of the top
        radius : 50, // The radius of the ellipse will be 50px
        strokeColor: ‘#808080’, // The outline of the ellipse will be draw in light grey
        strokeWidth : 1, // The thickness of the outline will be 1px
        content:‘#A0FFA0’ // The ellipse will be filled with the green color
      }
    }
  ]
}
```

In FIG. 1A, a structure of the visualization 100 is defined and a position of the ellipse within the visualization 110 is defined using pixel values within a content section of the code. Here, the visualization 100 includes a set of pixels in an X direction and a Y direction. For example, a center in the X axis is defined as X-axis pixel 100 and a center in the Y axis is defined as Y-axis pixel 150. In this case, the X-axis pixel values may start at 0 on the left hand side and increase by one as you go from the left edge of the visualization 100 to the right edge, and the Y-axis pixel values may start from 0 on the bottom and increase by one as you go from the bottom of the visualization 100 to the top. Additional features of the display of the ellipse 110 within the visualization 100 may be defined, including color, outline, thickness, radius, and the like.

In FIG. 1B, the ellipse 110 is positioned at a fixed position that is set based in relation on the outer boundaries or bounds of the visualization 100. A non-limiting example of code executed to generate the display of FIG. 1B is shown below.

```
viz = {
  version : “0.2”,
  content : [
    {
      type : ‘ellipse’,
      value: {
        centerX : layout.parent.bounds.centerX, // The absisse position of the center
will be at the center of the visualization container
        centerY : layout.parent.bounds.centerY, // The ordinate position of the center
will be at the center of the visualization container
        radius : 50,
        strokeColor: ‘#808080’,
        strokeWidth : 1,
        content:‘#A0FFA0’
      }
    }
  ]
}
```

In FIG. 1B, a position of the ellipse is defined using references to the layout of the visualization 100. Here, the center of the ellipse 110 is defined as being at the center of the first dimension (e.g., X-axis) of the visualization 100 and at the center of the second dimension (e.g., Y-axis) of the visualization 100. In FIG. 1C, a position of the ellipse 110 within the visualization 100 may be performed based on calculations. A non-limiting example of code executed to generate the display of FIG. 1C is shown below.

viz = {

version : “0.2”,
content : [

{

type : ‘ellipse’,
value : {

centerX : layout.parent.bounds.left + 0.8 *
layout.parent.bounds.width, // The

absisse position of the center will be at 80% of the left of the visualization
container

centerY : layout.parent.bounds.centerY,
radius : 50,
strokeColor: ‘#808080’,
strokeWidth : 1,
content:‘#A0FFA0’

}

}

]

}

In FIG. 1C, a position of the ellipse is defined using a calculation based on the layout of the visualization 100. Here, the X-axis position of the ellipse 110 is located at the right side of the visualization 100 based on a calculation putting the center of the ellipse 110 at 80% of the distance from the left edge to the right edge of the visualization 110.

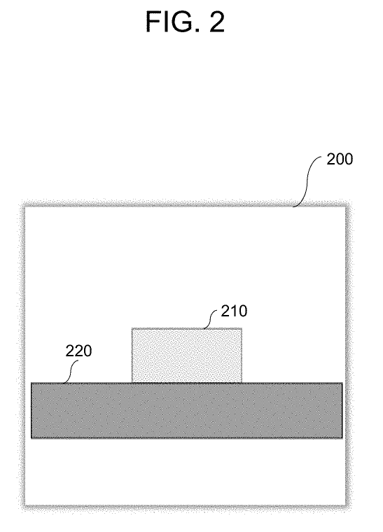

FIG. 2 illustrates a visualization of two shapes placed relative to the other in accordance with an example embodiment. Referring to FIG. 2, a first rectangle 210 is placed in relation to a second rectangle 220 within visualization 200 using code from the visualization library. A non-limiting example of code executed to generate the display of FIG. 2 is shown below.

viz = {

version : ″0.2″,
content : [

{

type : ′rectangle′,
id : ′main′, // An shape or layout can be referenced in an
other one using its id
value : {

centerX : layout.parent.bounds.centerX,
centerY : layout.parent.bounds.centerY,
width: 100,
height : 50,
strokeColor: ′#FF00FF′,
strokeWidth : 1,
content:′#A0FFA0′

}

},
{

type : ′rectangle′,
value : {

left: layout.parent.bounds.left,
right: layout.parent.bounds.right,
top: layout.parent.child(′main′).bounds.bottom, // We

place the top of this rectangle at the bottom of the first one called ‘main’

height: 50,
strokeColor: ′#000000′,
strokeWidth : 1,
content:′#A0A0A0′

}

}

]

}

In FIG. 2, the first rectangle 210 is defined as having an identification of “main” and is positioned at the center of the layout of the visualization 200 in both the X and Y directions using the content portion of the code. Furthermore, a width and a height of the rectangle are defined. In addition, a color and boundary width are also defined in this example. The second rectangle 220 and a top boundary of the second rectangle 220 is defined as being located at a bottom boundary of the first rectangle 210. That is, in this example, the second rectangle 220 is positioned relative to the first rectangle 210.

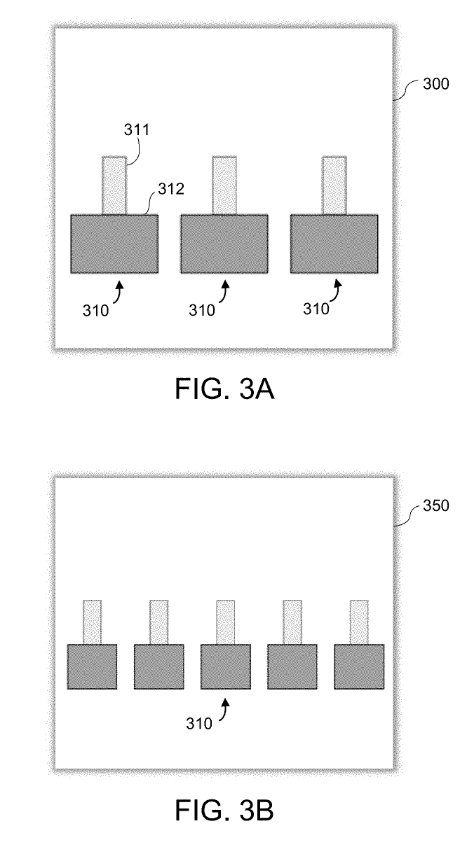

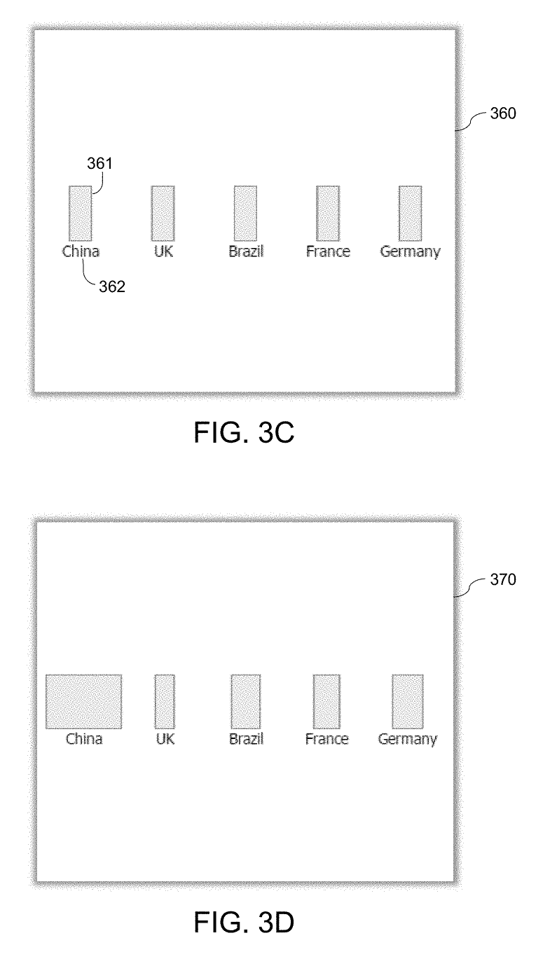

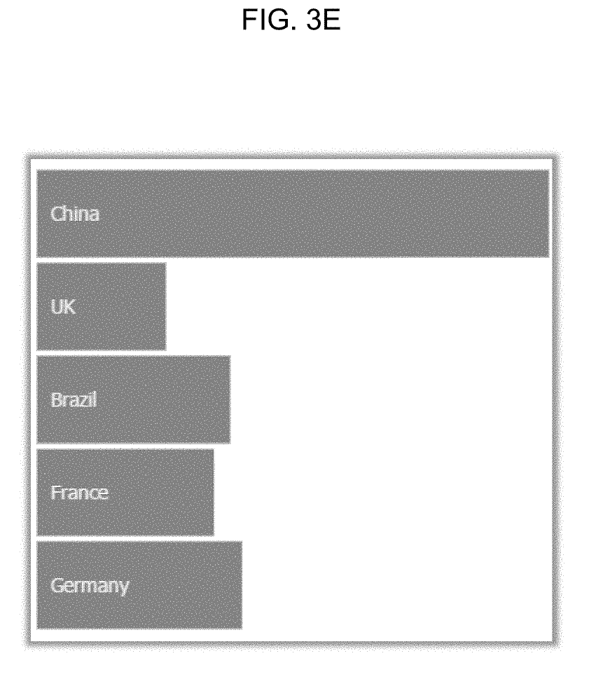

Layouts allow you to organize a visualization according to patterns. FIGS. 3A-3D illustrate layouts generated using patterns of shapes and a repeater in accordance with example embodiments. The examples of FIGS. 3A-3D are generated using code from the visualization library and the data query language of the visualization framework. The shapes and layouts described herein may be defined by the visualization library. FIG. 3A illustrates a layout 310 including first rectangle 311 and second rectangle 312 repeated three times within visualization 300 based on an arbitrary count value. A non-limiting example of code executed to generate the display of FIG. 3A is shown below.

viz = {

version: “0.2”,
content: [{

type: ‘column’, // We define a column layout
value: {

left: layout.parent.bounds.left,
top: layout.parent.bounds.top,
right: layout.parent.bounds.right,
bottom: layout.parent.bounds.bottom,
repeater: { // The repeater object defines how the layout will repeat (how many

times or on which data and what is the content of each cell

count: 3, // Here we repeat the content 3 times
content: [

{ // Start of the previous viz with the two rectangles

type: ‘rectangle’,
id: ‘main’,
value: {

centerX: layout.parent.bounds.centerX, // Now layout.parent does not

reference the visualization container anymore but the cell of the layout in which the object
is

centerY: layout.parent.bounds.centerY,
width: 20,
height: 50,
strokeColor: ‘#FF00FF’,
strokeWidth: 1,
content: ‘#A0FFA0’

}

}, {

type: ‘rectangle’,
value: {

left: layout.parent.bounds.left + 10,
right: layout.parent.bounds.right − 10,
top: layout.parent.child(‘main’).bounds.bottom,
height: 50,
strokeColor: ‘#000000’,
strokeWidth: 1,
content: ‘#A0A0A0’

} // End of the previous viz

}

]

}

}

}]

}

In this example, the code is used to define a column type layout, with each column having four sides (left, top, right, and bottom). The code also includes a “repeater” that is used to define the number of times that the layout is repeated within the visualization. Furthermore, the content portion of the repeater code is used to define the shapes/pattern of the layout 310 which includes the first and second rectangles 311 and 312. Accordingly, the layout 310 including the first and second rectangles 311 and 312 is repeated three times within the visualization 300. In this example, each layout includes shapes (i.e., two rectangles) however a layout may not include any shapes.

In FIG. 3B, data from a data file is combined with a layout pattern such that the number of times the layout 310 is repeated within visualization 350 is based on a data value taken from the data file. Table 1 below illustrates an example of a dataset.

TABLE 1

| Country | Vehicle | Number |
|---|---|---|
| China | Bicycle | 200 |
| China | Motorcycle | 500 |
| UK | Bicycle | 20 |
| UK | Motorcycle | 156 |
| Brazil | Bicycle | 36 |
| Brazil | Motorcycle | 228 |
| France | Bicycle | 79 |
| France | Motorcycle | 163 |
| Germany | Bicycle | 65 |
| Germany | Motorcycle | 215 |

According to various aspects, the data may be from a spreadsheet file, a document, a .csv file, an .xls file, and the like. The dataset in Table 1 includes three columns including a column for Country, Vehicle type, and the number of Vehicles. Using one or more functions of the data query language described herein the layout may be repeated based on data included in one of the columns from the data set. A non-limiting example of code executed to generate the display of FIG. 3B is shown below.

viz = {

version: “0.2”,
data: ‘tuto’, // We define that we work on the tutorial dataset
content: [{

type: ‘column’,
value: {

left: layout.parent.bounds.left,
top: layout.parent.bounds.top,
right: layout.parent.bounds.right,
bottom: layout.parent.bounds.bottom,
repeater: {

objects: data.distincts(‘Country’), // Here we repeat on the distinct values of the

column Country, so we repeat 5 times

content: [

{

type: ‘rectangle’,
id: ‘main’,
value: {

centerX: layout.parent.bounds.centerX,
centerY: layout.parent.bounds.centerY,
width: 20,
height: 50,
strokeColor: ‘#FF00FF’,
strokeWidth: 1,
content: ‘#A0FFA0’

}

}, {

type: ‘rectangle’,
value: {

left: layout.parent.bounds.left + 10,
right: layout.parent.bounds.right − 10,
top: layout.parent.child(‘main’).bounds.bottom,
height: 50,
strokeColor: ‘#000000’,
strokeWidth: 1,
content: ‘#A0A0A0’

}

}

]

}

}

}]

}

In this case, the code repeats the layout 310 a number of times equal to the number of distinct Country values included in the Country column of the dataset in Table 1. Here, the number of distinct countries is five (i.e., China, UK, France, Brazil, and Germany). As a result, the layout 310 is repeated five times within the visualization 350 of FIG. 3B. That is, the layout 310 in the column format is deleted five times.

FIG. 3C illustrates an example of displaying a visualization 360 including a column layout based on the data from Table 1 including a rectangle 361 and a label 362 for each layout. As is the case in FIG. 3B, the layout is repeated five times based on the number of distinct values for country included in Table 1. Furthermore, each column in the column layout corresponds to one country which may be referred to as data context. At each column, the data may be filtered for each country into further distinctions. However, FIG. 3C distinguishes each country in the column layout with a shape of the rectangle 361 and a label which 362 is based on a name of the country taken from Table 1. A non-limiting example of code executed to generate the display of FIG. 3C is shown below.

viz = {

version: “0.2”,
data: ‘tuto’,
content: [{

type: ‘column’,
value: {

left: layout.parent.bounds.left,
top: layout.parent.bounds.top,
right: layout.parent.bounds.right,
bottom: layout.parent.bounds.bottom,
repeater: {

objects: data.distincts(‘Country’),
content: [

{

type: ‘rectangle’,
id: ‘main’,
value: {

centerX: layout.parent.bounds.centerX,
centerY: layout.parent.bounds.centerY,
width: 20,
height: 50,
strokeColor: ‘#FF00FF’,
strokeWidth: 1,
content: ‘#A0FFA0’

}

}, {

type: ‘label’, // We show a label
value: {

centerX: layout.parent.bounds.centerX,
top: layout.parent.child(‘main’).bounds.bottom, // Under the rectangle
height: 20,
fontHeight: 14,
text: data.value(‘Country’) // The text of the label is the current value for

the Country

}

}

]

}

}

}]

}

In this case, the content section of the code defines the type of layout, and also defines a repeater based on the distinct amount of countries included in Table 1. Furthermore, a rectangle and a label are defined in the code for each column layout. FIG. 3D illustrates an example of a visualization 370 in which a sizing of a shape is defined based on a value from Table 1. In this example, the size of a rectangle for each country is based on the number of vehicles per country taken from Table 1. A non-limiting example of code executed to generate the display of FIG. 3D is shown below.

viz = {

version: “0.2”,
data: ‘tuto’,
content: [{

type: ‘column’,
value: {

left: layout.parent.bounds.left,
top: layout.parent.bounds.top,
right: layout.parent.bounds.right,
bottom: layout.parent.bounds.bottom,
repeater: {

objects: data.distincts(‘Country’),
content: [

{

type: ‘rectangle’,
id: ‘main’,
value: {

centerX: layout.parent.bounds.centerX,
centerY: layout.parent.bounds.centerY,
width: data.sum(‘Nb’) / 10, // We set the width of the rectangle to the

number of vehicles in the country divided by 10

height: 50,
strokeColor: ‘#FF00FF’,
strokeWidth: 1,
content: ‘#A0FFA0’

}

}, {

type: ‘label’,
value: {

centerX: layout.parent.bounds.centerX,
top: layout.parent.child(‘main’).bounds.bottom,
height: 20,
fontHeight: 14,
text: data.value(‘Country’)

}

}

]

}

}

}]

}

In this example, China has the widest rectangle because China has the most vehicles, while the UK has the smallest rectangle because the UK has the least amount of vehicles. In the example of FIG. 3D, a number of vehicles are used to define a number of pixels included in a width of the corresponding rectangle for each layout corresponding to each country, however, the embodiments are not limited thereto. FIG. 3E illustrates another example of a visualization 380 displaying a bar chart layout where each bar represents a country and bar has a width represented by the number of vehicles. A non-limiting example of code executed to generate the display of FIG. 3E is shown below.

viz = {

version: ‘0.2’,
data: ‘tuto’,
content: [{

type: ‘bar’,
value: {

left: layout.parent.bounds.left,
right: layout.parent.bounds.right,
top: layout.parent.bounds.top,
bottom: layout.parent.bounds.bottom,
repeater: {

objects: data.distincts(“Country”),
content: [{

type: ‘rectangle’,
value: {

top: layout.parent.bounds.top + 2,
bottom: layout.parent.bounds.bottom − 2,
left: layout.parent.bounds.left,
width: data.sum(“Nb”) * layout.parent.bounds.width /

data.parent.distincts(“Country”).sum(“Nb”).max, // All the science is here see explainations
below

content: [

“#008FD3”

]

}

}, {

type: ‘label’,
value: {

left: layout.parent.bounds.left + 10,
centerY: layout.parent.bounds.centerY,
height: 20,
fontHeight: 14,
strokeColor: “#EEEEEE”,
text: data.value(‘Country’)

}

}]

}

}

}]

}

In this example, the code defines a bar type layout, and the layout repeats each time for each country. The bar is shaped in the form of a rectangle beginning from the left side 381 of the visualization 380 and ending at a point with respect to the right side 382 based on the number of vehicles included in Table 1. In the example of FIG. 3E, there is a bar repeater on Country (one line by Country) containing a rectangle which left is at the left of each line and which right is at a value calculated as above. The Country with the largest number of vehicles may be represented by a bar taking the whole width of the visualization 380. The other bars may be sized proportionally to the biggest one. An example of computing the width of a bar is: actualValue*(maximumSizeOfBar/maximumValue), where actualValue=data.sum(“Nb”), maximumSizeOfBar=layout.parent.bounds.width, and maximumValue=data.parent.distincts(“Country”).sum(“Nb”).max.

As shown in some of the examples herein, a designer is able to navigate in the layout by using the layout.parent expression. It allows the designer to access the properties of a parent layout. (Example: layout.parent.bounds.left). A designer may also navigate deeper by using chained calls. (Example: layout.parent.parent.parent.bounds.left which creates access to the third parent). For example, the layout behavior may be defined by:
layout.parent—which accesses to the current cell;
layout.parent.parent—which accesses to the layout itself; and
layout.parent.parent.parent—which accesses to the parent of the layout.

A previous or next cell may also be called in layouts such as by:
layout.next—which accesses to the next cell;
layout.previous—which accesses to the previous cell; and
layout.objectIndex—which returns the index of the current cell.

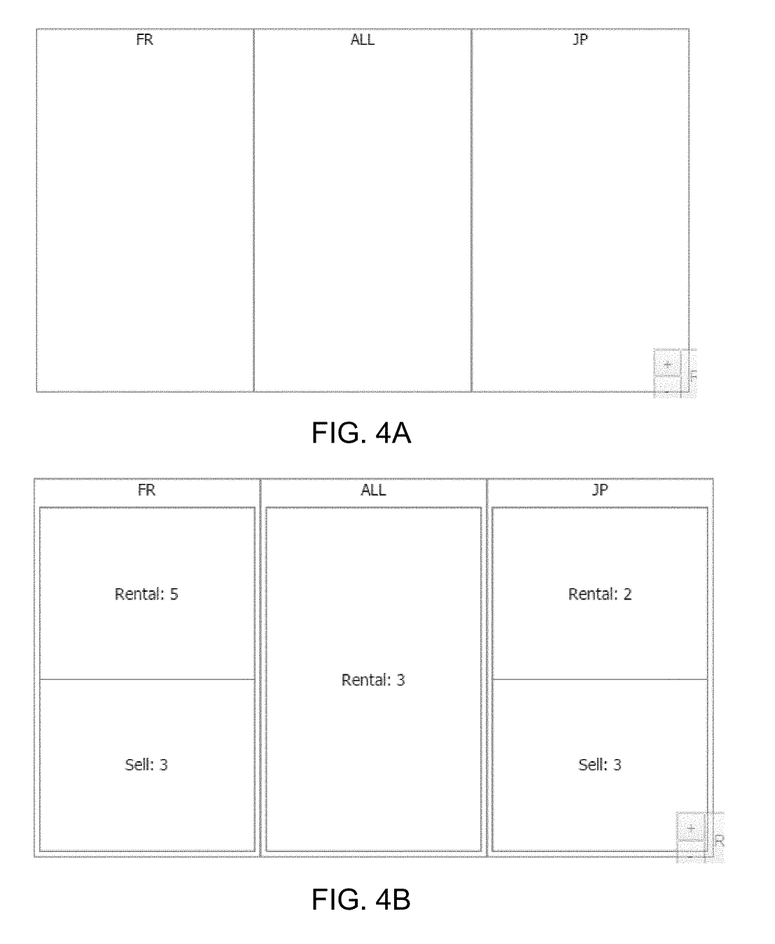

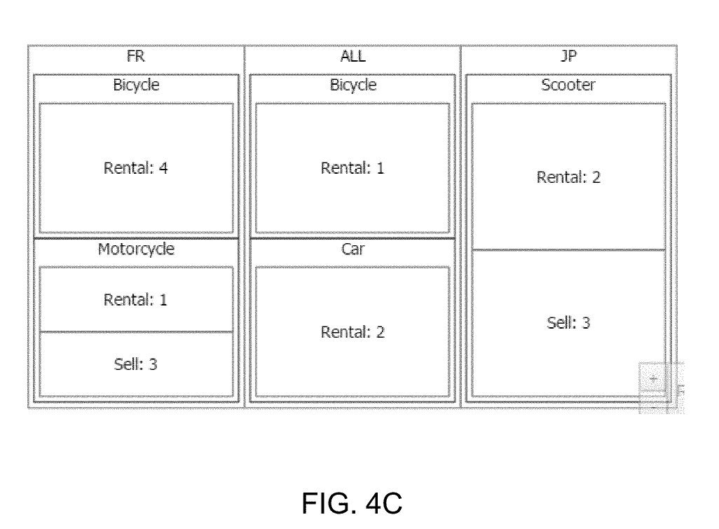

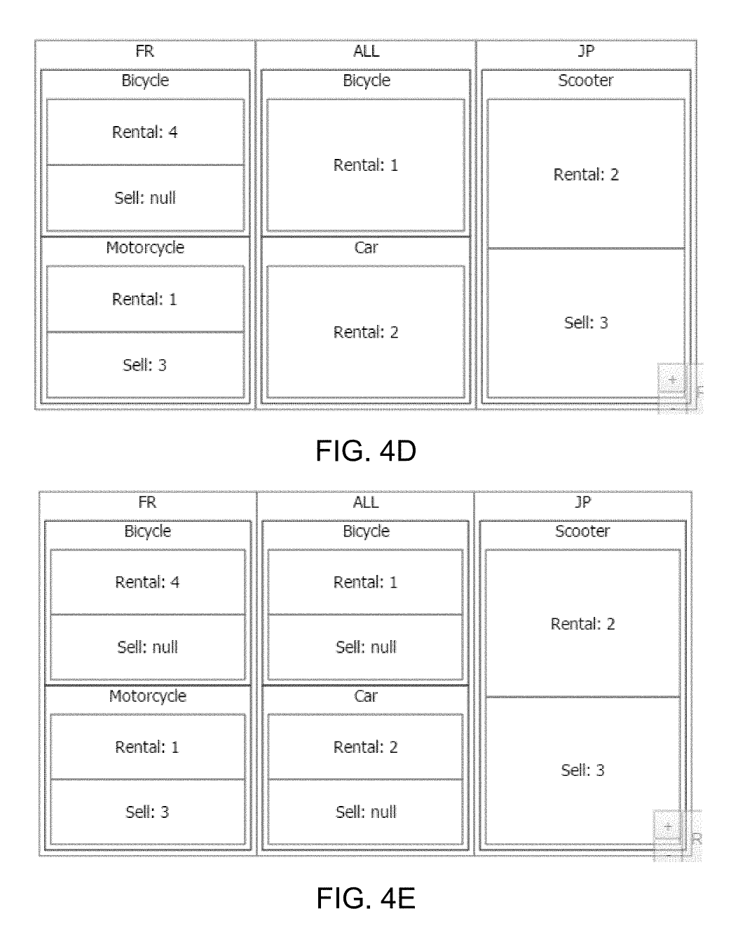

FIGS. 4A-4F illustrate examples of generating a column-based layout according to example embodiments. Data may be extracted or received from any number of sources such as files, emails, messages, memory, storage disks, and the like. The data may include a format such as a spreadsheet, a document, a notepad, and the like. Table 2 below illustrates an example of a dataset.

TABLE 2

| Country | Vehicle | Type | Nb |
|---|---|---|---|
| FR | Bicycle | Rental | 2 |
| FR | Bicycle | Rental | 2 |
| FR | Motorcycle | Rental | 1 |
| FR | Motorcycle | Sell | 1 |
| FR | Motorcycle | Sell | 2 |
| ALL | Bicycle | Rental | 1 |
| ALL | Car | Rental | 2 |
| JP | Scooter | Rental | 2 |
| JP | Scooter | Sell | 3 |

In Table 2, the number of bicycles, motorcycles, and cars sold and rented per country are shown. The table includes a column for country, vehicle type, purchase type, and a measure of the number (Nb) of vehicles sold or rented. In the example of FIGS. 4A-4F a visualization is generated showing the number of vehicles sold or rented and where. In these examples, a column is generated for each country indicating different values for rents or sells. In FIG. 4A, first columns with the name of the country are generated. Example of code for generating the visualization is shown below.

Column Layout:

objects: data.distincts(‘Country’)
content: [

Label: data.value(‘Country’)

]

In this example, the column layout defines a layout to be created where each object is inside a column next to each other. The object property is set to “data.distincts(‘Country’)”, which indicates that each column of the layout is to contain the data from the dataset for one distinct Country. Based on Table 2, the layout will include three columns, one for FR, one for ALL, and one for JP. The content property is used to define the content of each column. In this case, each column is to include a label displaying the name of the country. FIG. 4B is an example displaying the rents and the sales for each country. An example of the code for generating the visualization of FIG. 4B is shown below.

```
Column Layout:
  objects: data.distincts(“Country”)
  content: [
```

Label: data.value(“Country”),
Bar Layout:

objects: data.distincts(“Type ”),
content: [

Label: data.value(“Type”) + “: ” + data.sum(“Nb”)

]

]

In the example of FIG. 4B, content of each column is added and includes another layout. In this example, it is a bar layout and it does the same thing as the column layout but vertically. The repetition in this case is based on the type (rental or sell), and each line is to include a label displaying the type value and the number of sells or rents. In this example, data is filtered in each cell of the layouts. In each column the context is filtered on the current value of country (FR, ALL or JP) and in each line the context is filtered on the current value if type (rental or sell). Since there are no sales for the ALL value the line does not appear in this column. In the example of FIG. 4C, orthogonal axes are built in the visualization. An example of the code for generating the visualization of FIG. 4C is shown below.

```
Column Layout:
  objects: data.distincts(“Country”)
  content: [
```

Label: data.value(“Country”),
Bar Layout:

objects: data.distincts(“Vehicle”),
content: [

Label: data.value(“Vehicle”),
Bar Layout:

objects: data.distincts(“Type”),
content: [

Label: data.value(“Type”) + “: ” +
data.sum(“Nb”),

]

]

]

In this example, Country data values are placed in a column layout and include a list of vehicles if there are vehicles in the dataset for the specific country. For example, FR has no Scooter and therefore the layout may prevent a column for Scooter from being displayed. Furthermore, for each vehicle the number of pieces sold and rented may displayed. If there is no value of vehicles sold or rented, a null value may be displayed or the type (rental or sell) may be omitted. In the example of FIG. 4D, the objective is to iterate on all possible values of “Type” for each vehicle in each country. However, in some cases there is only a value for one type instead of values for both types. For example when we iterate on the Type value in the country of France (FR) and iterations for value Bicycles we only get a Rental Type because there is no data for FR/Bicycle/Sell in the dataset.

To iterate on all Type values for each vehicle in each country orthogonal axes may be used. In this example, the visualization library engine may establish some orthogonal axes for the iteration on Type column as shown in FIG. 4D. An example of the code for generating the visualization of FIG. 4D is shown below.

```
Column Layout:
  objects: data.distincts(“Country”)
  content: [
```

Label: data.value(“Country”),
Bar Layout:

objects: data.distincts(“Vehicle”),
content: [

Label: data.value(“Vehicle”),
Bar Layout:

objects: data.distincts(“Type”),
xTabContext: data.parent,
content: [

Label: data.value(“Type”) + “: ” +
data.sum(“Nb”),

]

]

]

In this example, a new property xTabContext is added to all Bar layouts on which the orthogonalization is done. Here, the orthogonalization is done on the Vehicle subaxis (data.parent) but the distinct values will still be filtered by the Country context. In this example, the “Sell” distinct value is generated for FR/Bicycle as a result of the orthogonalization because France has the “Sell” value for the Motorcycle. However, the “Sell” distinct value is not created for ALL/Bicycle or All/Car because ALL has no “Sell” value for all vehicles in the Country and the orthogonalization is on Vehicle. In order to generate distinct values of Type column for vehicles inside ALL context the orthogonalization may be performed on the upper axis as shown in FIG. 4E. An example of the code for generating the visualization of FIG. 4E is shown below.

```
Column Layout:
  objects: data.distincts(“Country”)
  content: [
```

Label: data.value(“Country”),
Bar Layout:

objects: data.distincts(“Vehicle”),
content: [

Label: data.value(“Vehicle”),
Bar Layout:

objects: data.distincts(“Type”),
xTabContext: data.parent.parent,
content: [

Label: data.value(“Type”) + “: ” +
data.sum(“Nb”),

]

]

]

In this case, the orthogonalization is done on the Country axis (data.parent.parent) and the result is all the Type distinct values for all countries are displayed in the visualization of FIG. 4E.

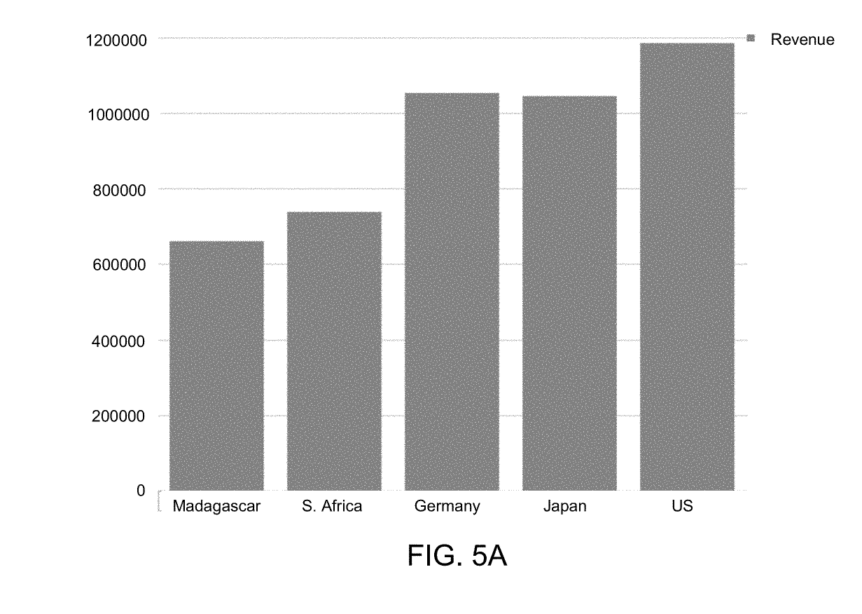

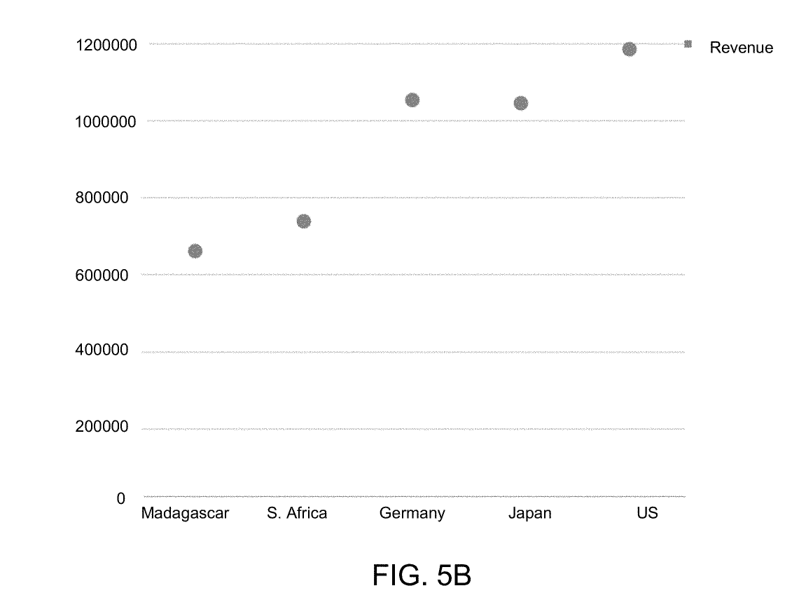

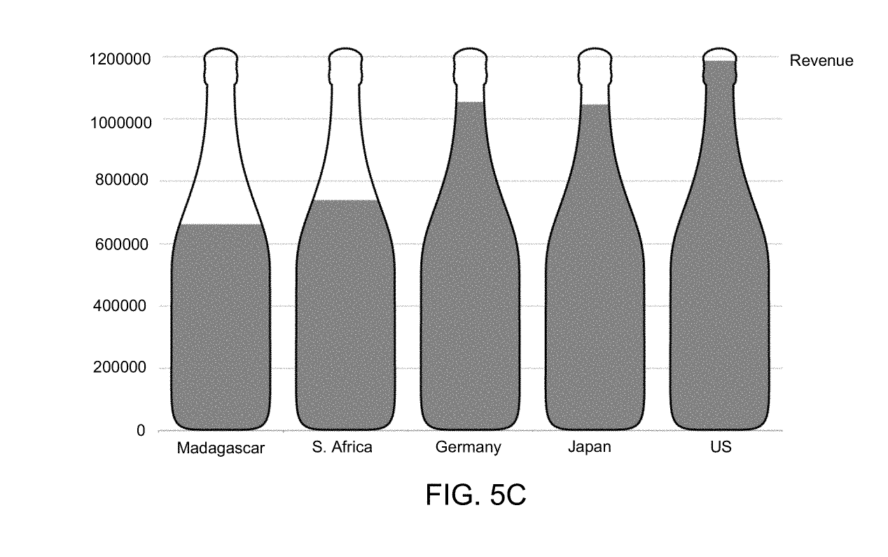

FIGS. 5A-5C illustrate examples of generating a bar graph based layout according to example embodiments. Referring to FIGS. 5A-5C, a bar chart is used to represent a set of data with vertical or horizontal rectangles. The bar chart may be used to show the comparison between different distinct values taken from a dataset. For example, in the visualization library the bar chart may be a shape or a combination of shapes (like rectangles, ellipses or labels) that can be placed and customized thought a set of properties. FIG. 5A illustrates an example of generating a bar chart visualization using the visualization library according to example embodiments. An example of the code for generating the visualization of FIG. 5A is shown below.

{

type: ′barChart′,
value: {

top: layout.parent.bounds.top,
left: layout.parent.bounds.left,
bottom: layout.parent.bounds.bottom,
right: layout.parent.bounds.right,
xAxis: $[‘Country’],
yAxis: $[$[‘Revenue’]],
scaleZero: $[true]

}

}

Just as all shapes included in the visualization library, the bar chart can be positioned relatively with the top, left, bottom and right properties of the visualization. The bar chart code defines various properties:
xAxis: An array of dimensions on which we will repeat on the tuples to create the xAxis of the Bar Chart (the values of Country in our sample);
yAxis: An array of arrays of measures. Each array of measures represent a new yAxis with its own scale. Although there can be only two displayed yAxis scale, the Bar Chart support an infinite number of yAxis but there will be no scale displayed;
color: An array of dimension on which we will repeat on the tuples for each value in xAxis. A bar will be displayed for each color tuple and each one will have an attributed color.
   There is also a set of properties that can be customized for the display of the chart:
scaleZero: an array of two booleans, by default at [false, false]. The first value is applied to the first yAxis and the second is applied to the second yAxis. The values determine whether each axis scale should include or not the value 0.
orientation: take “vertical” or “horizontal” values, by default at “vertical”. It defines the direction in which the bars are displayed.
mode: take “side” or “stacked” values, by default at “side”. In “side” mode all bars will be placed side by side. In “stacked” mode the bars sharing the same xAxis value and yAxis will be stacked together even if they have different color values.
legendVisibility: a boolean, by default at true. Define whether the legend of the chart is displayed or not.
titleVisibility: a boolean, by default at true. Define whether the title of the chart is displayed or not.
labelAxisVisibility: a boolean, by default at true. Define whether the labels for xAxis values are displayed or not.
scaleAxisVisibility: a boolean, by default at true. Define whether the scale axes are displayed for the measures in yAxis.
fontName: a string, should be a fontName recognized by the browser. Change the display font of all the texts for the chart.
fontSize: a numeric value, by default 12. Change the font size of all the texts for the chart.
barSpacingRatio: a numeric value, the number of pixels between each bar in a cluster
clusterSpacingRatio: a numeric value, the number of pixels between each cluster
emptyClusterVisibility: a boolean, by default at true. Define whether the clusters that contain no values are displayed or not.

According to various aspects, customization of the properties may be used to customize the display of each bar in the Bar Chart as shown in the example of FIG. 5B. An example of the code for generating the visualization of FIG. 5B is shown below.

{

type: ′barChart′,
value: {

top: layout.parent.bounds.top,
left: layout.parent.bounds.left,
bottom: layout.parent.bounds.bottom,
right: layout.parent.bounds.right,
xAxis: $[‘Country’],
yAxis: $[$[‘Revenue’]],
scaleZero: $[true],
barContent: [

{

type: ′ellipse′,
value: {

centerX: layout.parent.bounds.centerX,
centerY: layout.parent.bounds.top,
radius: 10,
content: color

}

}

]

}

}

In this example, the customization is done through the barContent property. This property can contain any visualization library content description, to render the bar with any other shapes available in the language. In the example of FIG. 5B, instead of displaying the default bars circles are displayed. The x position of the circle is defined to correspond to the center abscisse of what would have been the default bar and the y position of the circle is defined to correspond to the top ordinate of what would have been the default bar. The radius of the circle will be 10 pixels and its color the original color of the bar stocked in an automatically created variable named color.

Color may not be the only automatically created variable that can be used to customize each bar. Examples of other customizable variables are provided below.
color: contains the value of the orginal color of the bar
categoryAxisIndex: contains the index of the dimensions values on the axis
measureValue: contains the value for the current measure
serieIndex: contains the index of the serie
measureName: contains the name of the current measure
dimValues: contains the array of the current dimensions values
dimNames: contains the array of the current dimensions names,
barIndex: contains the index of the bar
barLeft: contains the left position of the current bar
barTop: contains the top position of the current bar
barWidth: contains the width of the current bar
barHeight: contains the height of the current bar
clusterLeft: contains the left position of the current cluster
clusterTop: contains the top position of the current cluster
clusterWidth: contains the width of the current cluster
clusterHeight: contains the height of the current cluster
plotLeft: contains the left position of the plotArea
plotTop: contains the top position of the plotArea
plotWidth: contains the width of the plotArea
plotHeight: contains the height of the plotArea

FIG. 5C illustrates another customized chart in which the values are represented using coke bottles. An example of the code for generating the visualization of FIG. 5C is shown below.

{

type: ‘barChart’,
value: {

top: layout.parent.bounds.top,
left: layout.parent.bounds.left,
bottom: layout.parent.bounds.bottom,
right: layout.parent.bounds.right,
xAxis: $[‘Country’],
yAxis: $[$[‘Revenue’]],
scaleZero: $[true],
barContent: [{

type: ‘svgShape2’,
id: ‘shape’,
value: {

source: ‘./images/bottle.svg’,
top: layout.parent.parent.bounds.top,
bottom: layout.parent.bounds.bottom,
centerX: layout.parent.bounds.centerX,
width: layout.parent.bounds.width,
strokeColor: ‘#000000’,
strokeWidth: 3,
content: [{

type: ‘rectangle’,
value: {

bottom: layout.parent.bounds.bottom,
top: layout.parent.parent.parent.bounds.top,
left: layout.parent.bounds.left,
right: layout.parent.bounds.right,
content: [

color

]

}

}]

}

}]

}

}

In this example, instead of displaying the default bars, bottles are filled to a level depending on the measure of “Revenue”. In the example of FIG. 5C, the bottle is an SVG shape that takes the whole height of the plot area and fills it depending on the original placement of the bar.

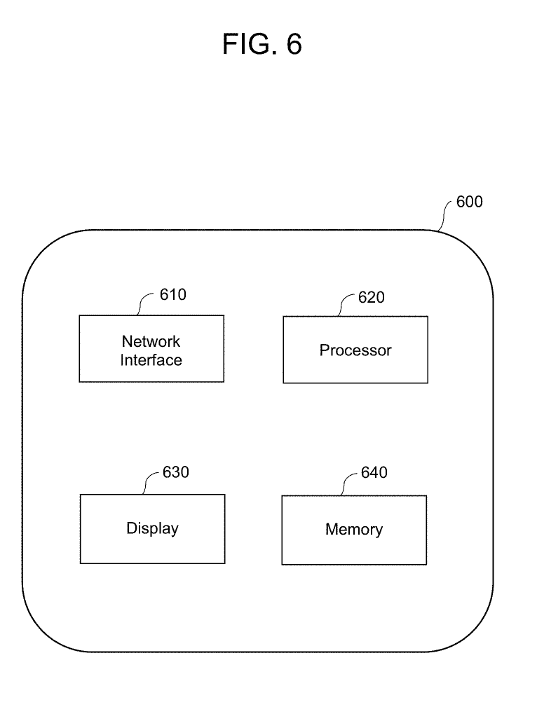

FIG. 6 illustrates a computing device 600 for generating a visualization in accordance with an example embodiment. The computing device 600 may be a workstation computer, a mobile device, a laptop, a server, a cloud device, a combination thereof, and the like. The computing device 600 may execute code such as described in any of the examples described with reference to FIGS. 1A-5C to generate visualizations. The visualizations may be displayed on a display of the computing device 600. As another example, the visualizations may be transmitted to another device for display, for example, through the Internet, or another network. The computing device 600 may generate visualizations based on the visualization framework described herein including the visualization library and the data query language.

Referring to FIG. 6, the computing device 600 includes a network interface 610, a processor 620, a display 630, and a memory 640. Although not shown in FIG. 6, the computing device may include other features, for example, an input unit, a transmitter, a receiver, and the like. The network interface 610 may transmit and receive data over a network such as the Internet. The processor 620 may include a single core processing device, a multicore processing device, or multiple processing devices. The processor may control the overall operations of the computing device 600. The display 630 may be an embedded display such as a touch screen on a mobile device or it may be an external display attached to the computing device through a connection such as a wired or wireless connection. The memory 640 may include any desired memory, for example, random access memory (RAM), one or more hard disks, cache, hybrid memory, an external memory, flash memory, and the like.

The memory 640 may store computer readable instructions including the visualization library and the data query language of the visualization framework described herein. The processor 620 may execute instructions stored in the memory 640. For example, the instructions may include a method for generating a visualization based on the visualization library and the data query language. Based on the executed instructions, the processor 620 may select a layout for the visualization from among a plurality of layouts included in the visualization library. Here, the layout may define a format for how content is spatially organized within the respective layout. The processor 620 may bind the layout to a dataset using one or more functions from the data query language. For example, the functions may include a repeater function defining a number of times a display of the layout is to be repeated based on data from the dataset, examples of which are described above. Furthermore, the processor 620 may cause the display 630 to display the visualization including the layout displayed a number of times as defined by the repeater function. For example, the repeater function may repeat the layout a plurality of times based on data included in the dataset. In some examples, the repeater function repeats the layout a plurality of times equal to an amount of distinct values within a column of the dataset.

For example, the display layout may include one or more shapes defined by the visualization library, and the format of the layout may define how the shapes are spatially organized within the layout. As an example, the layout format may include at least one of a bar chart format, a column format, a circular format, a grid format, and a hierarchy format. The layout may include boundaries that are defined based on boundaries of the visualization. The dataset may include various data formats such as a spreadsheet having a plurality of columns and a plurality of rows of data. As another example, the dataset may include a .csv file, a .xls file, a word file, a document file, and the like.

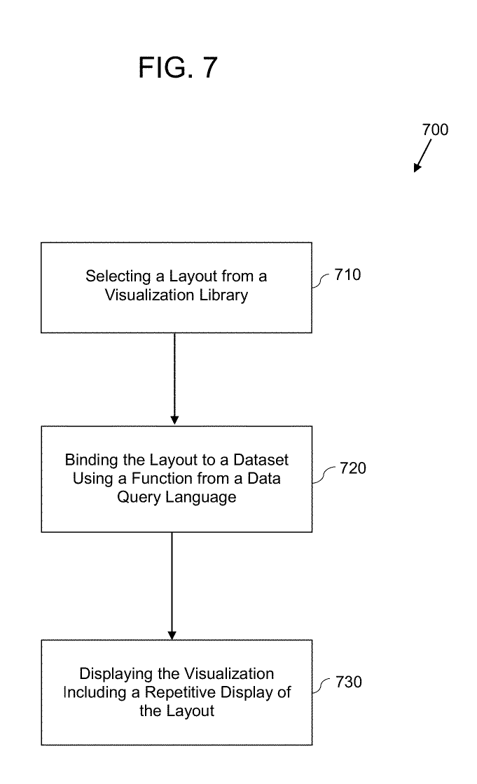

FIG. 7 is a diagram illustrating a method 700 for generating a visualization in accordance with an example embodiment. The method 700 may be performed by the computing device 600 described with reference to FIG. 6, or it may be performed by another device or a plurality of other devices. Referring to FIG. 7, the method includes selecting a layout for the visualization from among a plurality of layouts included in the visualization library, in 710. The layout may define a format for how content is spatially organized within the respective layout. The layout may include one or more shapes defined by the visualization library, and the format may define how the shapes are spatially organized within the layout. Examples of the layout format include a bar chart format, a column format, a circular format, a grid format, and a hierarchy format.

The method further includes binding the layout to a dataset using one or more functions from the data query language, in 720. For example, the one or more functions may include a repeater function defining a number of times a display of the layout is to be repeated based on data from the dataset. Here, the dataset may include various data formats such as a spreadsheet having a plurality of columns and a plurality of rows of data. As another example, the dataset may include a .csv file, a .xls file, a word file, a document file, and the like. According to various aspects, the repeater function may repeat the layout a plurality of times based on data included in the dataset. For example, the repeater function may repeat the layout a plurality of times equal to an amount of distinct values within a column of the dataset. The method further includes displaying the visualization including the layout displayed a number of times as defined by the repeater function, in 730.

According to various example embodiments, provided herein is a visualization library and a data query language that may be used in conjunction with the visualization library to generate customized visualizations using shapes and/or formats that are defined by the visualization library. The data query language may bind the shapes and/or formats to data included in a dataset to generate visualizations distinguishing values from the dataset from one another.

### Appendix A (Examples of Shapes)

Rectangle
Ellipse
Sector
Line
Polygon
Polyline
Path
Image
SvgShape
SvgShape2
Label
Group
Include
BarChart
BomChart
LineChart
BCGMatrixChart

Rectangle
This shape allows you to display a rectangle in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

Styling Properties
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
visible
Takes a boolean to define whether the shape is visible or not (by default at true)

Content Property
content
The content property can either be a color string or an array of other shapes. If it is a color, the shape will be filled with it. If it is an array of shapes, the shape will contain the shapes described, if the boundaries of those shapes are outside the original shape, their drawing will be clipped by the borders of the original shape.

Ellipse
This shape allows you to display an ellipse in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).
radius
Radius of the ellipse (in pixels) on both X-Axis and Y-Axis. Makes a circle.
radiusX
Radius of the ellipse (in pixels) on the X-Axis.
radiusY
Radius of the ellipse (in pixels) on the Y-Axis.

Styling Properties
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
visible
Takes a boolean to define whether the shape is visible or not (by default at true)

Content Property
content
The content property can either be a color string or an array of other shapes. If it is a color, the shape will be filled with it. If it is an array of shapes, the shape will contain the shapes described, if the boundaries of those shapes are outside the original shape, their drawing will be clipped by the borders of the original shape.

Sector
This shape allows you to display a sector in your visualization.

Positioning Properties
centerX
Position on X-Axis for the center of rotation of the sector (in pixels).
centerY
Position on Y-Axis for the center of rotation of the sector (in pixels).
radius
Radius of the sector (in pixels).
innerRadius
Inner Radius of the sector (in pixels). If there is none, the default value will be 0 and will produce a pie-sector starting from the center. Else you will design a “donut-sector”.
outerRadius
Outer radius of the sector (in pixels)

Styling Properties
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
visible
Takes a boolean to define whether the shape is visible or not (by default at true)

Content Property
content
The content property can either be a color string or an array of other shapes. If it is a color, the shape will be filled with it. If it is an array of shapes, the shape will contain the shapes described, if the boundaries of those shapes are outside the original shape, their drawing will be clipped by the borders of the original shape.

Line
This shape allows you to display a line in your visualization.

Positioning Properties
x0
Position on X-Axis of the starting point of the Shape (in pixels).
y0
Position on Y-Axis of the starting point of the Shape (in pixels).
x1
Position on X-Axis of the ending point of the Shape (in pixels).
y1
Position on Y-Axis of the ending point of the Shape (in pixels).

Styling Properties
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
dashPattern
Allow to draw dashed lines. The pattern is an array of pixels describing the number of pixels to draw and the number of pixels of space between drawn parts. Example: [3, 5] (3px drawn, 5px space).
visible
Takes a boolean to define whether the shape is visible or not (by default at true).

Polyline
This shape allows you to display a polyline in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).
coords
It is a string containing the coordinates of the shape. Actually, coordinates are vertices (defined by x coordinates and y coordinates in pixels). Both coordinates are separated by a space character and vertices are separated by a ‘,’ character. For example, we could have the following definition ‘20 20,40 25,60 40,80 120,120 140,50 120’.
The polyline shape size always respects the width/height size definition (if any), applying a horizontal/vertical scaling operation. If there is no size definition, the polyline shape respects the coordinates contained in the coords property.

Styling Properties
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
visible
Takes a boolean to define whether the shape is visible or not (by default at true)

Polygon
This shape allows you to display a polygon in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).
coords
It is a string containing the coordinates of the shape. Actually, coordinates are vertices (defined by x coordinates and y coordinates in pixels). Both coordinates are separated by a space character and vertices are separated by a ‘,’ character. For example, we could have the following definition ‘20 20, 40 25, 60 40, 80 120, 120 140, 50 120’.
The polygon shape size always respects the width/height size definition (if any), applying a horizontal/vertical scaling operation. If there is no size definition, the polygon shape respects the coordinates contained in the coords property.

Styling Properties
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
visible
Takes a boolean to define whether the shape is visible or not (by default at true)

Content Property
content
The content property can either be a color string or an array of other shapes. If it is a color, the shape will be filled with it. If it is an array of shapes, the shape will contain the shapes described, if the boundaries of those shapes are outside the original shape, their drawing will be clipped by the borders of the original shape.

Path
This shape allows you to draw very complex shapes, mixing line, curve to, quadratic Bezier curve, elliptical arc . . . . This shape follows the SVG specifications. Like for polygons, you can also define a content to fill/partially color fill it.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).
pathSegList
It is a string containing the commands of the shape. The following commands are available for data path:
M=moveto
L=lineto
H=horizontal lineto
V=vertical lineto
C=curveto
S=smooth curveto
Q=quadratic Bezier curve
T=smooth quadratic Bezier curveto
A=elliptical Arc
Z=closepath
For more information, see the w3 organization specification for the SVG path commands: https://www.w3.org/TR/SVG/paths.html
The path shape size always respects the width/height size definition (if any), applying a horizontal/vertical scaling operation. If there is no size definition, the path shape respects the coordinates contained in the coords property.

Styling Properties
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
visible
Takes a boolean to define whether the shape is visible or not (by default at true)

Content Property
content
The content property can either be a color string or an array of other shapes. If it is a color, the shape will be filled with it. If it is an array of shapes, the shape will contain the shapes described, if the boundaries of those shapes are outside the original shape, their drawing will be clipped by the borders of the original shape.

Image
This shape allows you to display an image in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

Styling Properties
source
Define the path of the image that we want the system to display.
visible
Takes a boolean to define whether the shape is visible or not (by default at true)

SvgShape
This shape allows you to display a static SVG in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

Styling Properties
source
Define the path of the SVG that we want the system to display.
visible
Takes a boolean to define whether the shape is visible or not (by default at true)

SvgShape2
This shape allows you to display an SVG that can be filled with a color or other shapes in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

Styling Properties
source
Define the path of the SVG that we want the system to display.
strokeColor
Color used to draw the “line”, “borders” of the shape. Example: ‘#101010’, ‘rgba(135, 135, 135, 0)’.
strokeWidth
Thickness of the “line”, “borders” of the shape (in pixels).
visible
Takes a boolean to define whether the shape is visible or not (by default at true)

Content Property
content
The content property can either be a color string or an array of other shapes. If it is a color, the shape will be filled with it. If it is an array of shapes, the shape will contain the shapes described, if the boundaries of those shapes are outside the original shape, their drawing will be clipped by the borders of the original shape.

Label
This shape allows you to display a label in your visualization.

Positioning Properties
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).
maxWidth
The width the label will not exceed (in pixels). If the label width exceed this size it will be truncated using the defined ‘behavior’ parameter.

Styling Properties
text
The text of the label.
strokeColor
Color used to draw the text. Example: ‘#101010’, ‘rgba(135, 135, 135, 0)’.
fontName
Label font name. Default value is “Tahoma”.
fontHeight
Label font size (in pixels). Default size is 14.
fontStyle
Label font name. Possible values are: “normal”, “italic”. Default value is “Tahoma”.
fontWeight
Label font Weight. Possible values are: “normal”, “bold”. Default value is “normal”.
behavior
The behavior of the label if it exceed the maxWidth. Possible values are: “truncate”, “clip”, “scaleFont”, “truncateMiddle”, “truncateLeading”, “overflow” and “multiLine”.
fontAngle
The rotation angle of the font (in degrees). Default value is 0.
visible
Takes a boolean to define whether the shape is visible or not (by default at true).

Group
This shape allows you to display a group in your visualization. A group is a non-drawn shape that allows to group different shapes together. At the opposite of other shapes, the contained shapes will not be clipped.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

Styling Properties
visible
Takes a boolean to define whether the shape is visible or not (by default at true)

Content Property
content
The content property can only be an array of shapes, the shape will contain the shapes described, if the boundaries of those shapes are outside the original shape, their drawing will not be clipped by the borders of the original shape.

Include
This shape allows you to load and display another visualization description inside your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

Styling Properties
source
Define the path of the other visualization that we want the system to display.
visible
Takes a boolean to define whether the shape is visible or not (by default at true)

BarChart
This shape allows you to display a complex BarChart object in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

BarChart Feeding Properties
xAxis
An array of dimensions on which we will repeat on the tuples to create the xAxis of the Bar Chart
yAxis
An array of arrays of measures. Each array of measures represent a new yAxis with its own scale. Although there can be only two displayed yAxis scale, the BarChart support an infinite number of yAxis but there will be no scale displayed.
colors
An array of dimension on which we will repeat on the tuples for each value in xAxis. A bar will be displayed for each color tuple and each one will have an attributed color defined by the palette.

BarChart Properties
mode
Define how the bar will be placed in on cluster. Possible values are: “side”, “stacked”, “100Stacked”. Default value is “side”.
orientation
Define whether we display the bars vertically or horizontally. Possible values are: “vertical”, “horizontal”. Default value is “vertical”.
fontName
Font name. Default value is “Tahoma”.
dataLabelFontName
Font name for the data labels. Default value is “Tahoma”.
fontSize
Font size (in pixels). Default size is 14.
fontColor
Color used to draw the text. Example: ‘#101010’, ‘rgba(135, 135, 135, 0)’.
fontWeight
Font Weight. Possible values are: “normal”, “bold”. Default value is “normal”.
title
The title that will be displayed on the chart.
barGap
The number of pixels between each bar in one cluster.
barSize
The size in pixels of the bar. If orientation is vertical then it will modify the width of the bars and if orientation is horizontal then it will modify the height of the bars.
clusterGap
The number of pixels between each cluster.
barSpacingRatio
Takes a ratio between 0 and 1 defining the proportion taken by the bar in its original drawing space.
clusterSpacingRatio
Takes a ratio between 0 and 1 defining the proportion taken by the cluster inside in its original drawing space.
scaleMin
Takes an array of values, one for each value axis. Each value define the minimum value for its correspondent value axis.
scaleMax
Takes an array of values, one for each value axis. Each value define the maximum value for its correspondent value axis.
scaleZero
Takes an array of boolean, one for each value axis. Each Boolean define whether or not the zero value must be contained and displayed for its correspondent value axis.
palette
Takes an array of colors to define the color of each dimension value on the colorAxis
colorsOrder
Takes a boolean to define whether or not the bar should be ordered in each cluster depending on their color or depending on the input data order.
visibleClustersCount
The number of clusters to be drawn (by default all of them will be drawn).
plotAreaVisibility
Takes a boolean to define whether or not the plotArea of the chart should be displayed (by default at true).
labelAxisVisibility
Takes a boolean to define whether or not the dimension label axis of the chart should be displayed (by default at true).
scaleAxisVisibility
Takes an array of booleans to define whether or not each measure scale should be displayed (by default at true for each axis).
legendVisibility
Takes a boolean to define whether or not the legend of the chart should be displayed (by default at true).
titleVisibility
Takes a boolean to define whether or not the title of the chart should be displayed (by default at true).
dataLabelsVisibility
Takes a boolean to define whether or not the data labels of the chart should be displayed (by default at true).
dataLabelsVisibilityMode
Defines how data labels behave. If the property value equals “fixed”, all the data labels will be aligned to the top of the chart(vertical mode) or to the right of the chart (horizontal mode).
dimLabelsVisibility
Takes a boolean to define whether or not the dimension labels of the chart should be displayed inside the bars (by default at false).
aggregationDataLabelsVisibility
Takes a boolean to define if the chart should display aggregated data labels for barcharts in “stacked” mode.
noValueVisibility
Takes a boolean to define whether or not the chart should display the bar space for empty values. No bar will be displayed but the space for it to be drawn will be kept (by default at true).
emptyClusterVisibility
Takes a boolean to define whether or not the chart should display the cluster space if it is empty. No bar will be displayed but the space for the bars in the cluster to be drawn will be kept (by default at true). For this parameter to be taken in account the noValueVisibility parameter should be set at true.
invertStackedSegmentOrder
Takes a boolean to define whether or not the order of the stacked elements of the bars should be inverted.
noNiceTickMode
Takes a boolean to define whether or not the measure scale should use nice ticks to be displayed (by default at true).
interactivity
Takes a boolean to define whether or not the chart should be interactive or not (by default at true). If interactivity is not necessary you can have a performance gain by disabling interactivity.
hierarchyLabelBorder
Takes a boolean to define whether or not the chart should display borders around the dimension values on label axis (by default at false).
groupDimensionLabels
Takes a boolean to define whether or not the chart should group the same dimension values on label axis (by default at true).
usePareto
Takes a boolean to define whether or not the chart should display the pareto line (by default at false)
visible
Takes a boolean to define whether the shape is visible or not (by default at true)

BarChart Customization
barContent
The barContent property can either be a color string or an array of other shapes. If it is a color, the bar will be filled with it. If it is an array of shapes, all the bars will contain the shapes described, if the boundaries of those shapes are outside the original bar, their drawing will not be clipped by the borders of the original bar. In this context the user has access to some automatically created properties:
color: contains the value of the original color of the bar
categoryAxisIndex: contains the index of the dimensions values on the axis
measureValue: contains the value for the current measure
measureName: contains the name of the current measure
measureIndex: contains the index of the current measure
measureId: contains the id of current measure
serieIndex: contains the index of the serie
dimValues: contains the array of the current dimensions values
dimNames: contains the array of the current dimensions names
dimIds: contains the array of the current dimensions ids
barIndex: contains the index of the bar
barLeft: contains the left position of the current bar
barTop: contains the top position of the current bar
barWidth: contains the width of the current bar
barHeight: contains the height of the current bar
clusterLeft: contains the left position of the current cluster
clusterTop: contains the top position of the current cluster
clusterWidth: contains the width of the current cluster
clusterHeight: contains the height of the current cluster
plotLeft: contains the left position of the plotArea
plotTop: contains the top position of the plotArea
plotWidth: contains the width of the plotArea
plotHeight: contains the height of the plotArea
labelAxisContent
The labelAxisContent property is an array of other shapes. All the label Axis values will contain the shapes described, if the boundaries of those shapes are outside the original labelAxisArea, their drawing will not be clipped by the borders of the original area. In this context the user has access to some automatically created properties:
labelAxisValue: contains the value for the current dimension.
scaleAxisContent
The scaleAxisContent property is an array of other shapes. All the scale Axis values will contain the shapes described, if the boundaries of those shapes are outside the original labelAxisArea, their drawing will not be clipped by the borders of the original area. In this context the user has access to some automatically created properties:
scaleAxisValue: contains the current scale Axis value.

BomChart
This shape allows you to display a complex BomChart object in your visualization. A BomChart is a chart that displays one bar for each passed measure.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

BomChart Feeding Properties
measures
An array of measures, each one will be represented by a bar.

BomChart Properties
mode
Define how the bar will be placed in on cluster. Possible values are: “side”, “stacked”, “100Stacked”. Default value is “side”.
orientation
Define whether we display the bar vertically or horizontally. Possible values are: “vertical”, “horizontal”. Default value is “vertical”.
fontName
Font name. Default value is “Tahoma”.
fontSize
Font size (in pixels). Default size is 14.
fontColor
Color used to draw the text. Example: ‘#101010’, ‘rgba(135, 135, 135, 0)’.
title
The title that will be displayed on the chart.
barGap
The number of pixels between each bar in one cluster.
barSize
The size in pixels of the bar. If orientation is vertical then it will modify the width of the bars and if orientation is horizontal then it will modify the height of the bars.
clusterGap
The number of pixels between each cluster.
barSpacingRatio
Takes a ratio between 0 and 1 defining the proportion taken by the bar in its original drawing space.
clusterSpacingRatio
Takes a ratio between 0 and 1 defining the proportion taken by the cluster inside in its original drawing space.
scaleMin
Takes an array of values, one for each value axis. Each value define the minimum value for its correspondent value axis.
scaleMax
Takes an array of values, one for each value axis. Each value define the maximum value for its correspondent value axis.
scaleZero
Takes an array of boolean, one for each value axis. Each Boolean define whether or not the zero value must be contained and displayed for its correspondent value axis.
labelsMargin
palette
Takes an array of colors to define the color of each dimension value on the colorAxis
plotAreaVisibility
Takes a boolean to define whether or not the plotArea of the chart should be displayed (by default at true).
labelAxisVisibility
Takes a boolean to define whether or not the dimension label axis of the chart should be displayed (by default at true).
scaleAxisVisibility
Takes an array of booleans to define whether or not each measure scale should be displayed (by default at true for each axis).
legendVisibility
Takes a boolean to define whether or not the legend of the chart should be displayed (by default at true).
titleVisibility
Takes a boolean to define whether or not the title of the chart should be displayed (by default at true).
dataLabelsVisibility
Takes a boolean to define whether or not the data labels of the chart should be displayed (by default at true).
noValueVisibility
Takes a boolean to define whether or not the chart should display the bar space for empty values. No bar will be displayed but the space for it to be drawn will be kept (by default at true).
invertStackedSegmentOrder
Takes a boolean to define whether or not the order of the stacked elements of the bars should be inverted.
noNiceTickMode
Takes a boolean to define whether or not the measure scale should use nice ticks to be displayed (by default at true).
interactivity
Takes a boolean to define whether or not the chart should be interactive or not (by default at true). If interactivity is not necessary you can have a performance gain by disabling interactivity.
visible
Takes a boolean to define whether the shape is visible or not (by default at true)

BomChart Customization
barContent
The barContent property can either be a color string or an array of other shapes. If it is a color, the bar will be filled with it. If it is an array of shapes, all the bars will contain the shapes described, if the boundaries of those shapes are outside the original bar, their drawing will not be clipped by the borders of the original bar. In this context the user has access to some automatically created properties:
color: contains the value of the original color of the bar
measureValue: contains the value for the current measure
measureIndex: contains the index for the current measure
measureId: contains the id for the current measure
barIndex: contains the index of the bar
barLeft: contains the left position of the current bar
barTop: contains the top position of the current bar
barWidth: contains the width of the current bar
barHeight: contains the height of the current bar
plotLeft: contains the left position of the plotArea
plotTop: contains the top position of the plotArea
plotWidth: contains the width of the plotArea
plotHeight: contains the height of the plotArea

LineChart
This shape allows you to display a complex LineChart object in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

LineChart Feeding Properties
xAxis
An array of dimensions on which we will repeat on the tuples to create the xAxis of the Line Chart
yAxis
An array of arrays of measures. Each array of measures represent a new yAxis with its own scale. Although there can be only two displayed yAxis scale, the BarChart support an infinite number of yAxis but there will be no scale displayed.
colors
An array of dimension on which we will repeat on the tuples for each value in xAxis. A line will be displayed for each color tuple and each one will have an attributed color defined by the palette.

LineChart Properties
orientation
Define whether we display the lines vertically or horizontally. Possible values are: “vertical”, “horizontal”. Default value is “horizontal”.
fontName
Font name. Default value is “Tahoma”.
fontSize
Font size (in pixels). Default size is 14.
fontColor
Color used to draw the text. Example: ‘#101010’, ‘rgba(135, 135, 135, 0)’.
fontWeight
Font Weight. Possible values are: “normal”, “bold”. Default value is “normal”.
scaleMin
Takes an array of values, one for each value axis. Each value define the minimum value for its correspondent value axis.
scaleMax
Takes an array of values, one for each value axis. Each value define the maximum value for its correspondent value axis.
scaleZero
Takes an array of boolean, one for each value axis. Each Boolean define whether or not the zero value must be contained and displayed for its correspondent value axis.
labelsMargin
palette
Takes an array of colors to define the color of each dimension value on the colorAxis
plotAreaVisibility
Takes a boolean to define whether or not the plotArea of the chart should be displayed (by default at true).
labelAxisVisibility
Takes a boolean to define whether or not the dimension label axis of the chart should be displayed (by default at true).
scaleAxisVisibility
Takes an array of booleans to define whether or not each measure scale should be displayed (by default at true for each axis).
legendVisibility
Takes a boolean to define whether or not the legend of the chart should be displayed (by default at true).
dataLabelsVisibility
Takes a boolean to define whether or not the data labels of the chart should be displayed (by default at true).
dimLabelsVisibility
Takes a boolean to define whether or not the dimension labels of the chart should be displayed inside the bars (by default at false).
labelAxisStyle
scaleAxisStyle
edgesSummaryScaleAxisWidth
markerRadius
Defines the marker radius size (in pixels).
maximumMarkerDensity
noNiceTickMode
Takes a boolean to define whether or not the measure scale should use nice ticks to be displayed (by default at true).
interactivity
Takes a boolean to define whether or not the chart should be interactive or not (by default at true). If interactivity is not necessary you can have a performance gain by disabling interactivity.
hierarchyLabelBorder
Takes a boolean to define whether or not the chart should display borders around the dimension values on label axis (by default at false).
plotAreaOffsetTop
dataHolesMode

BCGMatrixChart
This shape allows you to display a complex MCGMatrixChart object in your visualization.

Positioning Properties
width
Width of the shape area (in pixels).
height
Height of the shape area (in pixels).
left
Left position of the shape area (in pixels).
right
Right position of the shape area (in pixels).
top
Top position of the shape area (in pixels).
bottom
Bottom position of the shape area (in pixels).
centerX
Position on X-Axis to center horizontally the shape area (in pixels).
centerY
Position on Y-Axis to center vertically the shape area (in pixels).

BCGMatrixChart Feeding Properties
dim
A dimension on which we will repeat on each distinct value to create a bubble
measureX
A measure that will define the position on the xAxis for each bubble
measureY
A measure that will define the position on the yAxis for each bubble
measureBubble
A measure that will define the size of each bubble
colorDim
A dimension that will define the color of the bubble

BCGMatrixChart Properties
mode
Define whether we will display BCG Chart or a Scatter. Possible values are: “BCG”, “Scatter”. Default value is “BCG”.
fontName
Font name. Default value is “Tahoma”.
fontSize
Font size (in pixels). Default size is 14.
fontColor
Color used to draw the text. Example: ‘#101010’, ‘rgba(135, 135, 135, 0)’.
paletteName
Takes an array of colors to define the color of each dimension value on the colorDimAxis.
emphasisPaletteName
Takes an array of colors to define the color of each emphasized dimension value on the colorDimAxis
dataLabelsVisibility
Takes a boolean to define whether or not the data labels of the chart should be displayed (by default at true).
invertXOrder
Takes a boolean to define whether or not the direction of the xAxis is inverted.
invertYOrder
Takes a boolean to define whether or not the direction of the yAxis is inverted.
interactivity
Takes a boolean to define whether or not the chart should be interactive or not (by default at true). If interactivity is not necessary you can have a performance gain by disabling interactivity.
atypicalValues
Takes an array of dimension values. All contained values will take a specific color from the emphasis palette.

### Appendix B (Examples of Functions of the Data Query Language)

distincts(colName1, . . . , colNameN)

### Description:

This function's purpose is to create DataContexts on one or multiple columns.

### Applied On:

A DataContext

### Parameters:

colName: a string that is a column name

### Returns:

An array of DataContexts. Each DataContext points on a different distinct value (or tuple) of the column names passed as arguments.

### Examples:

### In the RootDataContext:

data.distincts(“Continent”) returns an array of 3 DataContexts.
Europe context containing 8 lines
Asia context containing 5 lines
North America context containing 6 lines
data.distincts(“Continent”, “Competition”) return an array of 11 DataContexts
Europe/10000m context containing 2 lines
Europe/5000m context containing 3 lines
Europe/100m context containing 1 lines
Europe/1500m context containing 1 lines
Europe/200m context containing 1 lines
Asia/1500m context containing 2 lines
Asia/200m context containing 3 lines
North America/10000m context containing 1 lines
North America/5000m context containing 3 lines
North America/200m context containing 1 lines
North America/1500m context containing 1 lines

### In Europe DataContext:

data.distincts(“Country”) returns an array of 2 DataContexts.
France context containing 3 lines
Germany context containing 5 lines
   value(colName)

### Description:

This function's purpose is to retrieve the value of a specific column.

### Applied On:

A DataContext or an array of DataContexts

### Parameters:

colName (optional): a string that is a column name

### Returns:

On a DataContext
If a colName is passed it will return the value for the colName in the first line of the DataContext
If no colName is passed it will return the current value of the DataContext
On an array of DataContexts
If a colName is passed it will return an array containing the values for the colName in the first line of the different DataContexts
If no colName is passed it will return an array containing the current value of the different DataContexts

### Examples:

### In the RootDataContext:

data.value( )returns null because there is no current value
data.value(“Country”) returns France
data.distincts(“Continent”).value( )returns [Europe, Asia, North America]
data.distincts(“Continent”).value(“Country”) returns [France, China, USA]

### In Europe DataContext

data.value( )returns Europe
data.value(“Country”) returns France
data.distincts(“Country”).value( )returns [France, Germany]
data.distincts(“Country”).value(“Competition”) returns [10000m, 10000m]
   sum(colName)

### Description:

This is an aggregation function, it returns the sum aggregation on a column or the sum of numeric elements of an array.

### Applied On:

If one colName is passed, on a DataContext or an array of DataContexts
If no colName is passed, on an array of values

### Parameters:

colName (optional): a string that is a column name

### Returns:

If one colName is passed it will return the sum of all the values for the colName in the DataContext.
If no colName is passed it will the sum of all numeric elements in the array.

### Examples:

### In the RootDataContext:

data.sum(“Speed”) returns 387
data.distincts(“Continent”).sum(“Speed”) returns [154, 127, 106]
[8, 5, 6].sum( )returns 19
[5.1, “18.6”, “hi”].sum( )returns 23.7

### In Europe DataContext:

data.sum(“Speed”) returns 154
data.distincts(“Country”).sum(“Speed”) returns [65, 89]
   max(colName)

### Description:

This is an aggregation function, it returns the maximum aggregation on a column or the maximum numeric value of an array.

### Applied On:

If one colName is passed, on a DataContext or an array of DataContexts
If no colName is passed, on an array of values

### Parameters:

colName (optional): a string that is a column name

### Returns:

If one colName is passed it will return the maximum of all the values for the colName in the DataContext.
If no colName is passed it will the maximum of all numeric elements in the array.

### Examples:

### In the RootDataContext:

data.max(“Speed”) returns 40
data.distincts(“Continent”).max(“Speed”) returns [40, 31, 32]
[8, 5, 6].max( )returns 8
[5.1, “18.6”, “hi”].max( )returns 18.6

### In Europe DataContext:

data.max(“Speed”) returns 40
data.distincts(“Country”).max(“Speed”) returns [40, 30]
   min(colName)

### Description:

This is an aggregation function, it returns the minimum aggregation on a column or the minimum numeric value of an array.

### Applied On:

If one colName is passed, on a DataContext or an array of DataContexts
If no colName is passed, on an array of values

### Parameters:

colName (optional): a string that is a column name

### Returns:

If one colName is passed it will return the minimum of all the values for the colName in the DataContext.
If no colName is passed it will the minimum of all numeric elements in the array.

### Examples:

### In the RootDataContext:

data.min(“Speed”) returns 10
data.distincts(“Continent”).min(“Speed”) returns [10, 19, 11]
[8, 5, 6].min( )returns 5
[5.1, “18.6”, “hi”].min( )returns 5.1

In Europe DataContext:
data.min(“Speed”) returns 10
data.distincts(“Country”).min(“Speed”) returns [10, 11]
   avg(colName)

### Description:

This is an aggregation function, it returns the average aggregation on a column or the average of numeric elements of an array.

### Applied On:

If one colName is passed, on a DataContext or an array of DataContexts
If no colName is passed, on an array of values

### Parameters:

colName (optional): a string that is a column name

### Returns:

If one colName is passed it will return the average of all the values for the colName in the DataContext.
If no colName is passed it will the average of all numeric elements in the array.

### Examples:

### In the RootDataContext:

data.avg(“Speed”) returns 20.368421
data.distincts(“Continent”).avg(“Speed”) returns [19.25, 25.4, 17.666666]
[8, 5, 6].avg( )returns 6.333333333
[5.1, “18.6”, “hi”].avg( )returns 11.85

### In Europe DataContext:

data.avg(“Speed”) returns 19.25
data.distincts(“Country”).avg(“Speed”) returns [21.666666, 17.8]
   count(colName)

### Description:

This is an aggregation function, it returns the count aggregation on a column or the number of lines (or unique tuples for all other columns).

### Applied On:

A DataContext or an array of DataContexts

### Parameters:

colName (optional): a string that is a column name

### Returns:

If a colName is passed it will return the number of distinctValue for the colName in the DataContext.
If no colName is passed it will return the number of lines (or unique tuples for all other columns) in the DataContext.

### Examples:

### In the RootDataContext:

data.count( )returns 19
data.distincts(“Continent”).count( )returns [8, 5, 6]
data.distincts(“Continent”, “Competition”).count( )returns [2, 3, 1, 1, 1, 2, 3, 1, 3, 1, 1]
data.count(“Continent”) returns 3
data.count(“Continent”, “Competition”) returns 11
data.distincts(“Continent”).count(“Country”) returns [2, 2, 2]

### In Europe DataContext:

data. count( )returns 8
data.distincts(“Country”).count( )returns [3, 5]
data.distincts(“Country”, “Athlete Name”).count( )returns [2, 1, 3, 1, 1]
data. count(“Country”) returns 2
data. count(“Country”, “Athlete Name”) returns 5
data.distincts(“Country”).count(“Athlete Name”) returns [2, 3]
   filter(expr)

### Description:

This purpose of this function is to filter the current DataContext or to select the right DataContexts from an original array of DataContexts.

### Applied On:

A DataContext or an array of DataContexts.

### Parameters:

A formula which evaluates to a Boolean condition based on either dimension or measure but not both.
As for sort method dimensions are introduced via the value method and measures via any aggregate method (sum, max, min, avg)

### Returns:

Applied on a DataContext
A filtered DataContext depending on the boolean condition
Applied on an array of DataContexts
A filtered array of DataContexts depending on the boolean condition

### Examples:

### In the RootDataContext:

data.filter(value(“Continent”)==“Europe”).distincts(“Country”) returns an array of 2 DataContexts (The countries in Europe)
France context containing 3 lines
Germany context containing 5 lines
data.distincts(“Continent”).filter(avg(‘Speed’)>19) returns an array of 2 DataContexts (The continents for which the speed in above 19)
Europe context containing 8 lines
Asia context containing 5 lines
sort( . . . )

### Description:

This purpose of this function is to sort an array of DataContexts on dimensions or measures

### Applied On:

An array of DataContexts

### Parameters:

Several options are possible:

sort( )

or sort (sortOrder)
or sort (sortItemList)
or sort (sortItemList, sortOrder)
sortItemList is a non empty list of sort items
sortItem is a tuple [sortFormula, sortOrder], the latest being optional
sortOrder is an expression evaluating to either “ascending” or “descending”.
   If no order is specified, “ascending” is taken as default value.
sortFormula is an expression resulting in the value on which sort is performed; it can be either a numeric or a string
   If no formula is specified, sort is performed on the column passed as argument of the previous distincts method.
   Sort formula can be based on either dimension or measure but not both. As for filter method dimensions are introduced via the value method and measures via any aggregate method.

### Returns:

The ordered array of DataContexts on which it is applied to.

### Examples:

data.distincts(“Country”).sort( )returns an array of countries DataContexts sorted by the name of the countries ascending
data.distincts(“Country”).sort(“descending”) returns an array of countries DataContexts sorted by the name of the countries descending
data.distincts(“Country”).sort([value(“Continent”), “descending”], [value(“Athlete”)]) returns an array of countries DataContexts sorted by continent descending and then by athlete ascending
data.distincts(‘Country’).sort([min(‘Speed’)], ‘descending’) returns an array of countries DataContexts sorted by their minimum speed ascending and then by the name of the countries descending

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the invention as set forth in the appended claims.

1. A visualization device comprising:
a memory device; and
a processor configured to execute instructions stored in the memory device, the instructions comprising a method for generating a visualization of text-based data using a visualization library and a data query language, the method comprising:
selecting at least one shape as content for the visualization;
selecting a layout for the visualization from among a plurality of layouts included in the visualization library, the layout defining a format for how the at least one shape is spatially organized within the respective layout;
binding the layout to a dataset using one or more functions from the data query language, the one or more functions comprising a repeater function defining a number of times a display of the layout is to be repeated within a boundary of the visualization based on a numerical property of textual data included in the dataset; and
displaying the visualization including the layout displayed a number of times as defined by the repeater function.

2. (canceled)

3. The visualization device of claim 1, wherein the layout comprises at least one of a bar chart format, a column format, a circular format, a grid format, and a hierarchy format.

4. The visualization device of claim 1, wherein the dataset comprises a spreadsheet having a plurality of columns and a plurality of rows of textual data.

5. The visualization device of claim 1, wherein the repeater function repeats the layout a plurality of times based on a numerical property determined from a plurality of rows of textual data included in one column of the dataset.

6. The visualization device of claim 4, wherein the repeater function repeats the layout a plurality of times equal to an amount of distinct textual values for the textual data within a column of the dataset.

7. The visualization device of claim 1, wherein the layout comprises a boundary that is defined based on the boundary of the visualization, and position functions which define a position of each repeated layout within the boundaries of the layout.

8. A computer implemented method for creating a visualization of text-based data using a visualization library and a data query language, the method comprising:
selecting at least one shape as content for the visualization;
selecting a layout for the visualization from among a plurality of layouts included in the visualization library, the layout defining a format for how the at least one shape is spatially organized within the respective layout;
binding the layout to a dataset using one or more functions from the data query language, the one or more functions comprising a repeater function defining a number of times a display of the layout is to be repeated within a boundary of the visualization based on a numerical property of textual data included in the dataset; and
displaying the visualization including the layout displayed a number of times as defined by the repeater function.

9. (canceled)

10. The method of claim 8, wherein the layout comprises at least one of a bar chart format, a column format, a circular format, a grid format, and a hierarchy format.

11. The method of claim 8; wherein the dataset comprises a spreadsheet having a plurality of columns and a plurality of rows of textual data.

12. The method of claim 8, wherein the repeater function repeats the layout a plurality of times based on a numerical property determined from a plurality of rows of textual data included in one column of the dataset.

13. The method of claim 12, wherein the repeater function repeats the layout a plurality of times equal to an amount of distinct textual values for the textual data within a column of the dataset.

14. The method of claim 8, wherein the layout comprises a boundary that is defined based on the boundary of the visualization, and position functions which define a position of each repeated layout within the boundaries of the layout.

15. A non-transitory computer readable medium having stored therein instructions that when executed cause a computer to perform a method for creating a visualization of text-based data using a visualization library and a data query language, the method comprising:
selecting at least one shape as content for the visualization;
selecting a layout for the visualization from among a plurality of layouts included in the visualization library, the layout defining a format for how the at least one shape is spatially organized within the respective layout;
binding the layout to a dataset using one or more functions from the data query language, the one or more functions comprising a repeater function defining a number of times a display of the layout is to be repeated within a boundary of the visualization based on a numerical property of textual data included in the dataset; and
displaying the visualization including the layout displayed a number of times as defined by the repeater function.

16. (canceled)

17. The non-transitory computer readable medium of claim 15, wherein the layout comprises at least one of a bar chart format, a column format, a circular format, a grid format, and a hierarchy format.

18. The non-transitory computer readable medium of claim 15, wherein the dataset comprises a spreadsheet having a plurality of columns and a plurality of rows of textual data.

19. The non-transitory computer readable medium of claim wherein the repeater function repeats the layout a plurality of times based on a numerical property determined from a plurality of rows of textual data included in one column of the dataset.

20. The non-transitory computer readable medium of claim 15, wherein the layout comprises a boundary that is defined based on the boundary of the visualization, and position functions which define a position of each repeated layout within the boundaries of the layout.

21. The visualization device of claim 1, wherein they layout further comprises at least one of a size and a fill-level dynamically representing a contextual value of the textual data included in the dataset.
